(19) United States
(12) Patent Application Publication
(10) Pub. No.: US 2011/0052974 A1
(43) Pub. Date: Mar. 3, 2011

(54) SECONDARY BATTERY

(75) Inventor: Dae-Kyu Kim, Yongin-si (KR)

(73) Assignee: Samsung SDI Co., Ltd., Yongin-si (KR)

(21) Appl. No.: 12/874,128

(22) Filed: Sep. 1, 2010

(30) Foreign Application Priority Data
Sep. 2, 2009 (KR) 10-2009-0082371

(51) Int. Cl. H01M 2/02

(52) U.S. Cl. 429/164; 429/176

(57) ABSTRACT

A secondary battery including an electrode assembly and a can housing the electrode assembly, wherein the can has at least one recessed portion in a side surface thereof. Here, a value obtained by subtracting a diameter of the electrode assembly from a gap length between facing inner surfaces of the can ranges from about −0.12 mm to about 0.10 mm.

### CROSS-REFERENCE TO RELATED APPLICATION

This application claims the benefit of Korean Patent Application No. 10-2009-0082371, filed Sep. 2, 2009 in the Korean Intellectual Property Office, the disclosure of which is incorporated herein by reference.

### BACKGROUND

1. Field

Aspects of the present invention relate to a secondary battery, and more particularly, to a secondary battery that prevents movement of an electrode assembly housed in a can, thereby increasing stability.

2. Description of the Related Technology

Secondary batteries are rechargeable and thus repeatedly used. Therefore, secondary batteries are widely used as energy sources for electronic devices in various fields. While the secondary batteries have been generally used in compact electronic devices (such as MP3 players, cameras, and portable multimedia players (PMPs)) due to their small capacity, as high-capacity and high-output batteries are developed, the secondary batteries are also being applied to hybrid cars, handheld electronic/electrical appliances and so forth on a commercial level.

Among these secondary batteries, a lithium secondary battery is widely used due to a high operating voltage and a high energy density per unit weight. The lithium secondary battery is formed by housing an electrode assembly and an electrolyte in an outer case, and sealing the outer case. The lithium secondary battery may be classified as a can type or a pouch type depending on the shape of the outer case. Furthermore, the can type may be classified as a cylindrical shape or a prismatic shape. The cylindrical secondary battery is formed by housing an electrode assembly and an electrolyte in a can, and inserting an insulating gasket and a cap assembly into an opening of the can to seal the can.

Generally, the cylindrical secondary battery is formed by inserting the insulating gasket into the opening of the can, inserting components of the cap assembly into the insulating gasket, and crimping a side of the can and the insulating gasket to seal the can. When the electrode assembly is housed in the can, a predetermined space needs to be ensured between an outer surface of the electrode assembly and an inner surface of the can to prevent damage to the electrode assembly due to contact with the can.

As described above, since the electrode assembly is housed in the can but not fixed to the can, if the space between the inner surface of the can and the outer surface of the electrode assembly is large, the electrode assembly may be easily moved as a result of an external impact. Due to the movement of the electrode assembly, an attached electrode tab may be detached, or a crack may be generated in the electrode tab. Thus, it is difficult to ensure stability.

### SUMMARY

Aspects of the present invention provide a secondary battery that has a recessed portion formed on a side surface of a can to optimize a gap between an inner surface of the can and an outer surface of an electrode assembly, and thus an electrode plate has no defect, and movement of the electrode assembly is effectively prevented, thereby increasing stability.

According to an aspect of the present invention, there is provided a secondary battery having an electrode assembly and a can housing the electrode assembly, wherein the can includes at least one recessed portion in a side surface thereof, and a value obtained by subtracting a diameter of the electrode assembly from a gap length between facing inner surfaces of the can ranges from about −0.12 mm to about 0.10 mm.

According to another aspect of the present invention, there is provided a secondary battery including an electrode assembly and a can housing the electrode assembly, wherein the can includes at least one recessed portion in a side surface thereof, and a sum of a gap length between an inner surface of the can where a recessed portion, of the at least one recessed portion, is disposed and an outer surface of the electrode assembly and a gap length between the inner surface of the can facing the recessed portion and the outer surface of the electrode assembly ranges from about −0.12 mm to about 0.10 mm.

According to an aspect of the present invention, the at least one recessed portion includes a pair of recessed portions which face each other, and a value obtained by subtracting the diameter of the electrode assembly from the gap between the inner surfaces of the facing recessed portions may range from about −0.12 mm to about 0.10 mm.

According to an aspect of the present invention, when only one recessed portion is formed, the sum of the gap length between the inner surface of the can in which the recessed portion is disposed and the outer surface of the electrode assembly and the gap length between the inner surface of the can in which the recessed portion is not disposed and the outer surface of the electrode assembly may range from about −0.12 mm to about 0.10 mm.

According to an aspect of the present invention, the at least one recessed portion may be formed along a lengthwise or circumferential direction of the can.

According to an aspect of the present invention, the at least one recessed portion may be formed to correspond to a side surface of the electrode assembly.

According to an aspect of the present invention, the at least one recessed portion may be formed to correspond to an upper, middle and/or lower portions of the electrode assembly.

According to an aspect of the present invention, the at least one recessed portion may have a polygonal or semi-circular cross-section.

According to another aspect of the present invention, there is provided a can to house an electrode assembly of a secondary battery, the can including: a bottom surface; a side surface extending from the bottom surface to form a housing for the electrode assembly; at least one protruding portion extending from the side surface into the housing, wherein a value obtained by subtracting a diameter of an area to house the electrode assembly from a gap length between the at least one protruding portion and a facing inner surface of the can ranges from −0.696864% to 0.5858% of the diameter of the area to house the electrode assembly.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is an exploded perspective view of a secondary battery according to an embodiment of the present invention;

FIG. 2 is a cross-sectional view briefly illustrating a part of the secondary battery according to an embodiment of the present invention;

FIG. 3 is a plan view of the cross-sectional view of FIG. 2;

FIG. 4 is a cross-sectional view briefly illustrating a part of a secondary battery according to another embodiment of the present invention; and

FIGS. 5A to 5F are plan and cross-sectional views of various recessed portions according to embodiments of the present invention.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures. Moreover, in the drawings, the length and thickness of an element or a region may be exaggerated for clarity. Furthermore, a part being “connected” with another part means that the parts are “directly connected” or “electrically connected” with each other, possibly having a third device therebetween.

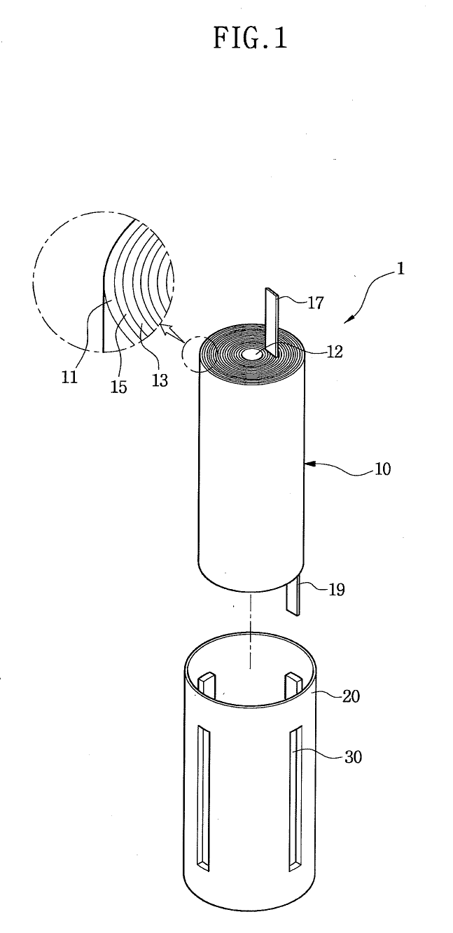

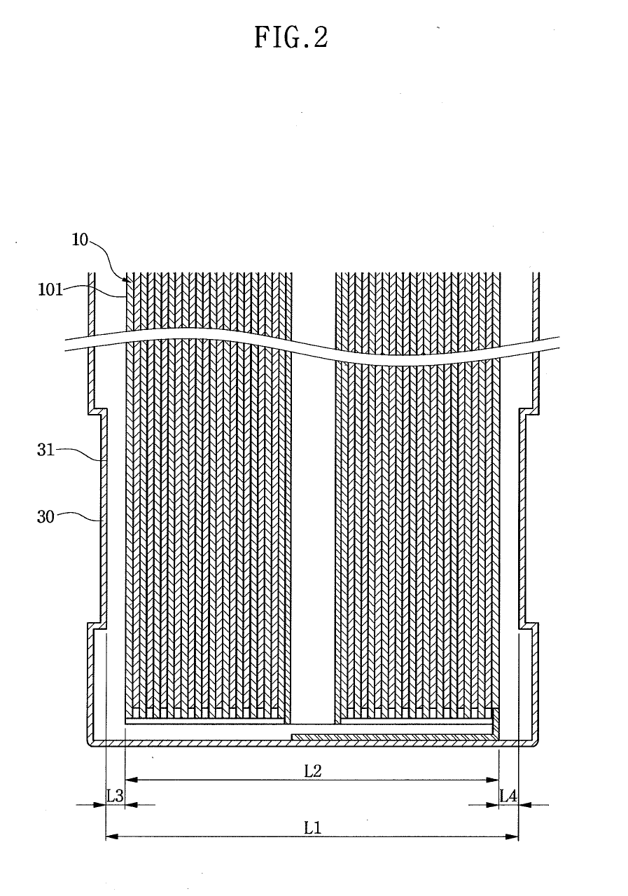

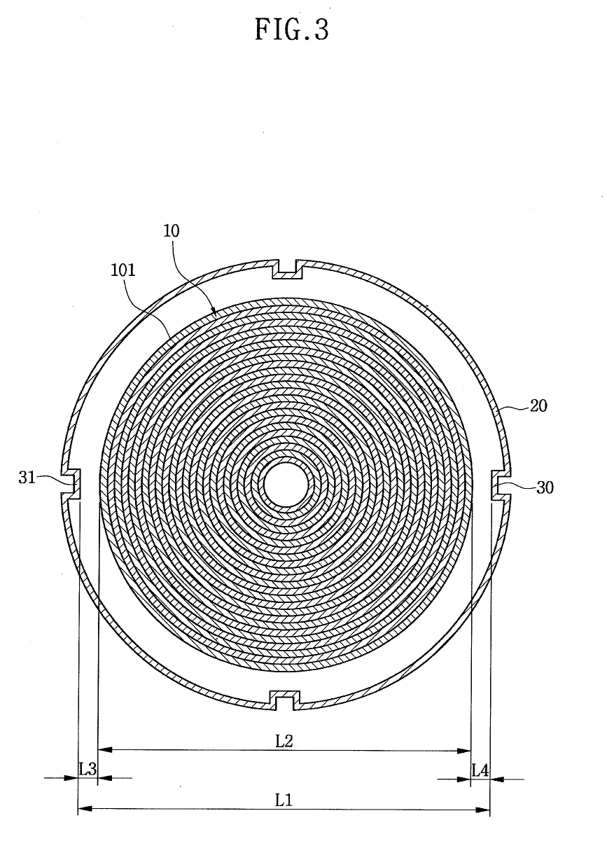

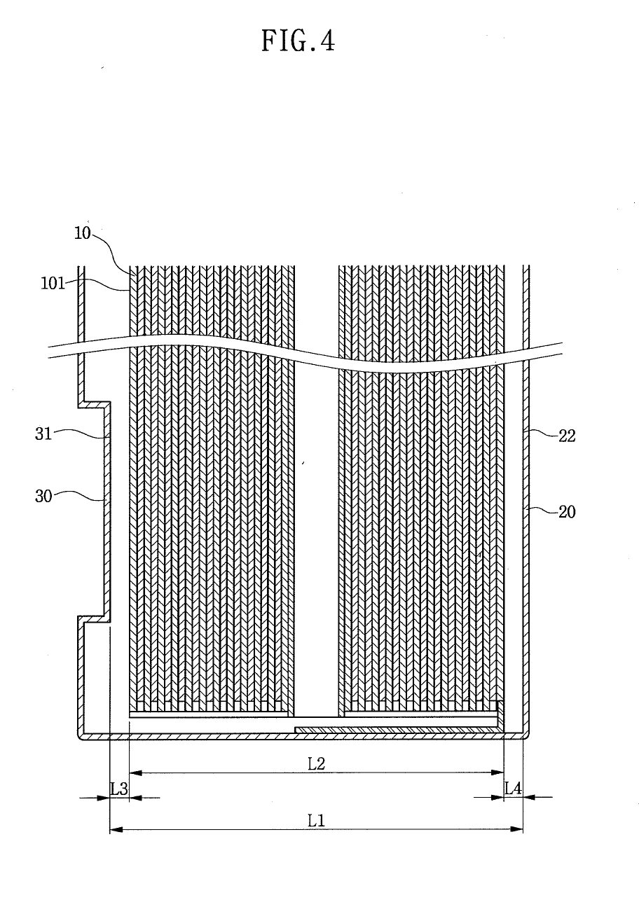

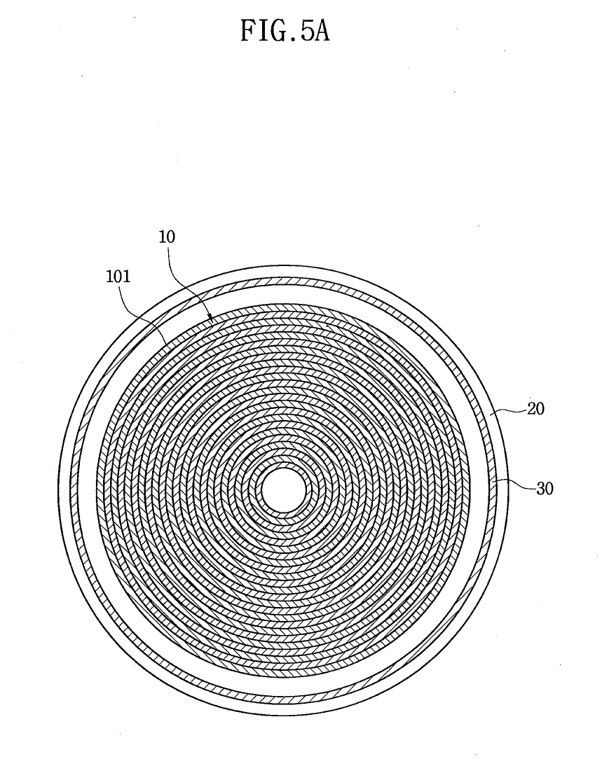

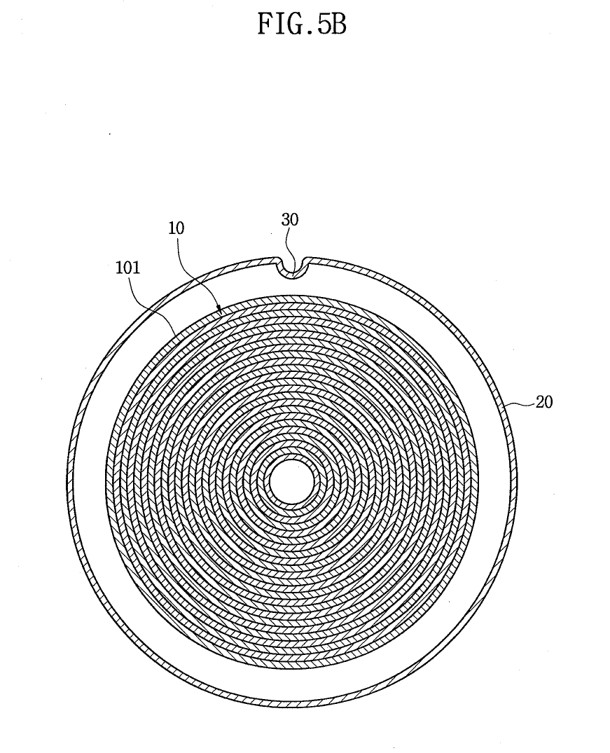

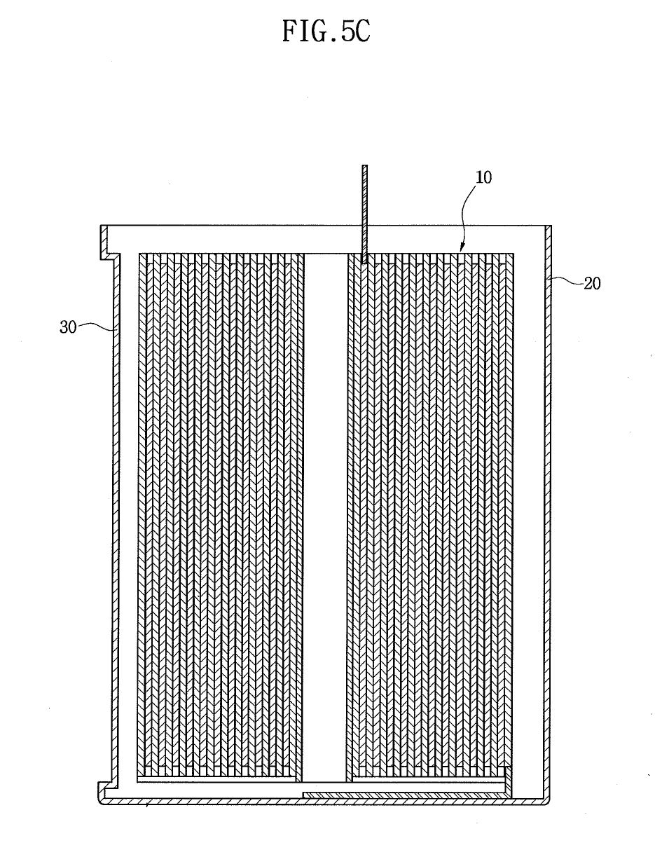

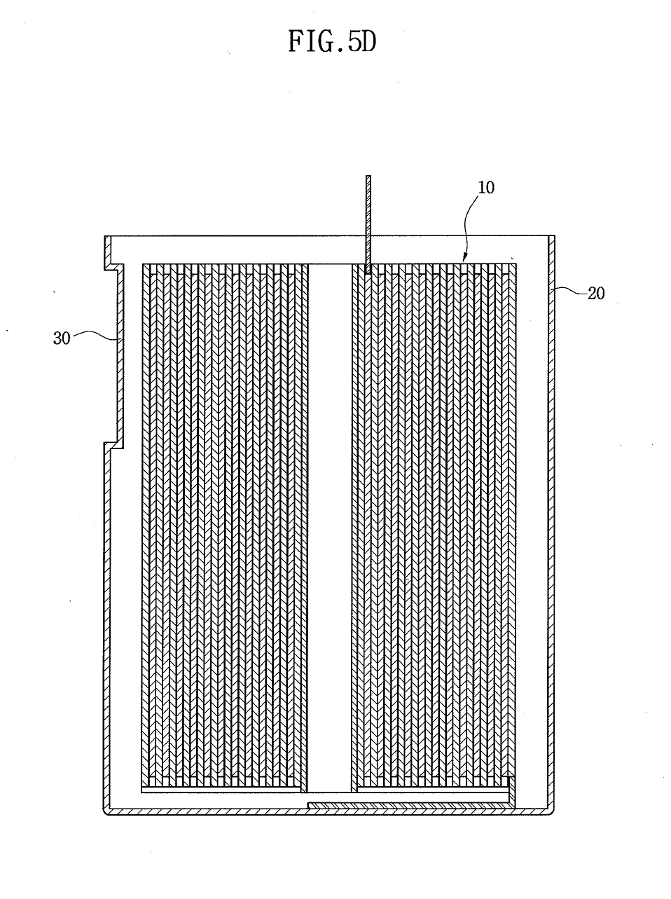

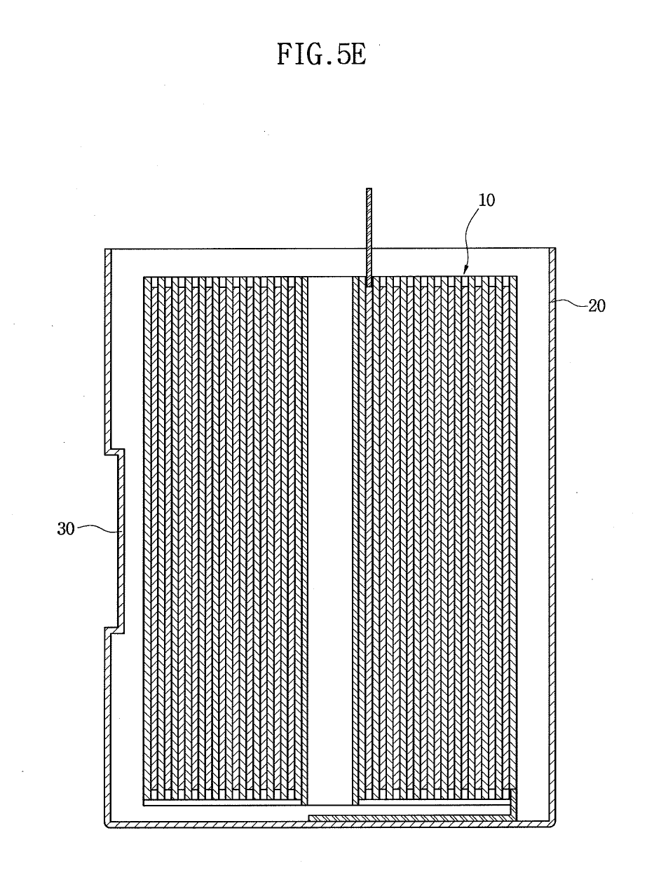

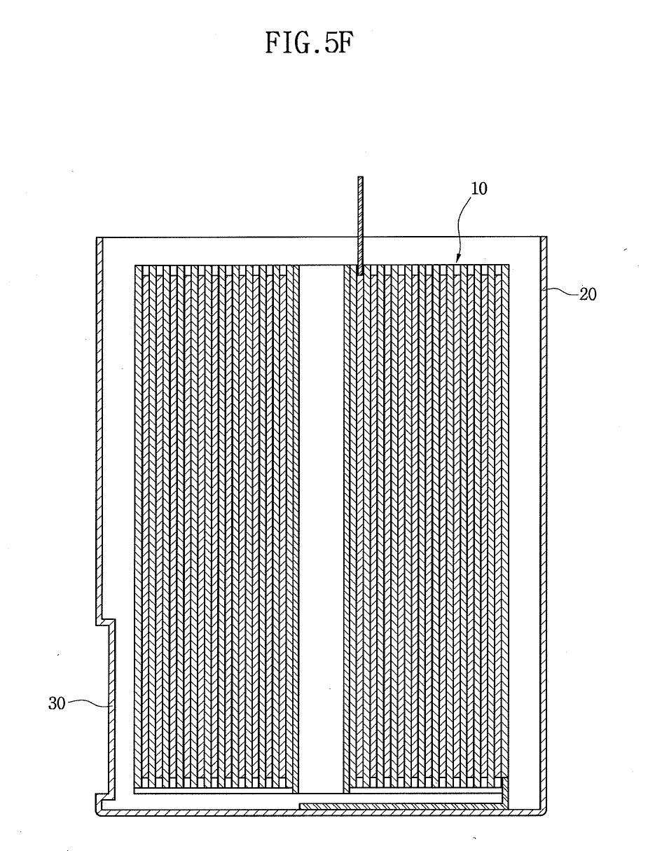

FIG. 1 is an exploded perspective view of a secondary battery 1 according to an embodiment of the present invention, FIG. 2 is a cross-sectional view briefly illustrating a part of the secondary battery 1 according to an embodiment of the present invention, FIG. 3 is a plan view of the cross-sectional view of FIG. 2, FIG. 4 is a cross-sectional view briefly illustrating a part of the secondary battery 1 according to another embodiment of the present invention, and FIGS. 5A to 5F are plan and cross-sectional views of various recessed portions according to embodiments of the present invention.

Referring to FIG. 1, the secondary battery 1 includes an electrode assembly 10, a can 20 housing the electrode assembly 10, and a recessed portion 30 formed by partially recessing a side surface of the can 20. The recessed portion 30 will be described in further detail with reference to FIGS. 2 through 5F. However, it is understood that, in the present description, the recessed portion 30 is recessed from an interior of the can 20 such that the recessed portion 30 protrudes towards an inside of the can 20. The electrode assembly 10 includes a first electrode plate 11, a second electrode plate 13, and a separator. The first and second electrode plates 11 and 13 have different polarities from each other. The separator 15 is disposed between the first and second electrode plates 11 and 13 to prevent a short circuit between the first and second electrode plates 11 and 13.

While not limited thereto, the electrode assembly 10 may be formed in a jelly roll shape, i.e, by stacking and winding the first electrode plate 11, the second electrode plate 13 and the separator 15. Thus, the electrode assembly 10 is formed in a circular shape, and has a hollow center 12 in a middle thereof. Here, a component disposed at an outermost portion of the electrode assembly 10 formed in a jelly-roll shape may, although not necessarily, be a finishing tape attached to an outer surface of the electrode assembly 10 to prevent unwinding of an outer end of the electrode assembly 10.

The first and second electrode plates 11 and 13 are each formed by applying a positive or negative electrode active material slurry to a collector plate made of aluminum or copper. For example, a positive electrode plate is formed by applying the positive electrode active material slurry to the collector plate made of aluminum, and a negative electrode plate is formed by applying the negative electrode active material slurry to the collector plate made of copper. The first and second electrode plates 11 and 13 include non-coating portions, respectively, through which the collector plate is exposed since no active material slurry is applied thereon. First and second electrode tabs 17 and 19 are electrically connected to the non-coating portions, respectively. To be specific, the first electrode tab 17 is connected to the non-coating portion formed on the first electrode plate 11, and the second electrode tab 19 is connected to the non-coating portion formed on the second electrode plate 13. As illustrated in FIG. 1, the first electrode tab 17 is led upward from the electrode assembly 10 to an opening of the can 20, and the second electrode tab 19 is led downward from the electrode assembly 10 to a bottom of the can 20. However, it is understood that aspects of the present invention are not limited thereto. For example, the second electrode tab 19 may be led upward and the first electrode tab 17 downward. Alternatively, the first and second electrode tabs 17 and 19 may be led in the same direction as each other

The can 20 may be formed of a metal such as aluminum or stainless steel, and formed in a cylindrical shape having an opening at one end to house the electrode assembly 10. The electrode assembly 10 is inserted into the can 20 through the opening.

Although not shown in the drawings, the secondary battery 1 may include a cap assembly to seal the can 20. Between the opening of the can 20 and the cap assembly, an insulating gasket may be interposed to prevent a short circuit between the can 20 and the cap assembly. The cap assembly is coupled to the opening of the can 20 to seal the can 20, and blocks electrical flow when an internal pressure of the can 20 increases more than a predetermined level, thereby increasing stability of the secondary battery 1. In addition, the secondary battery 1 may include insulating plates disposed on and/or under the electrode assembly 10 to prevent a short circuit between the electrode assembly 10 and the can 20 and lessen an external impact, and a center pin disposed in the hollow center 20 of the electrode assembly 10 to prevent deformation of the electrode assembly 10 and exhaust an internal gas generated from the electrode assembly 10.

Referring to FIGS. 2 and 3, the secondary battery 1 includes a recessed portion 30 formed in the can 20. For convenience of description, the present embodiment illustrates four recessed portions 30, which are separately formed in pairs to face each other, and the electrode assembly 10, which is disposed in the middle of the can 20. However, aspects of the present invention are not limited thereto, as more or less than four recessed portions 30 may be provided and/or the recessed portions 30 may not be provided in pairs. The recessed portion 30 may be formed by partially recessing a side surface of the can 20 by pressing, so that no additional material is needed.

As shown in FIGS. 2 and 3, L1 is a length of a gap between inner surfaces 31 of the recessed portions 30 facing each other, L2 is a diameter of the electrode assembly 10, and L3 and L4 are respective lengths of gaps between inner surfaces 31 of the recessed portions 30 and outer surfaces 101 of the electrode assembly 10. A value (L1−L2) is obtained by subtracting the diameter L2 of the electrode assembly from the length of the gap L1 between the inner surfaces 31 of the facing recessed portions 30. The (L1−L2) value for the shown example is maintained in the range from about −0.12 mm to about 0.10 mm. In the present embodiment, the electrode assembly 10 is disposed in the middle of the can 20, and thus both lengths L3 and L4 between the inner surfaces 31 of the recessed portions 30 and the outer surfaces 101 of the electrode assembly 10 are equal to (L1−L2)/2 (i.e., the lengths L3 and L4 are equal to each other). However, it is understood that the (L1−L2) value can be other values, depending on the size of the battery.

As a result, in the cross-sectional view, the sum of both lengths L3 and L4 between the inner surfaces 31 of the recessed portions 30 formed in the can 20 and the outer surfaces 101 of the electrode assembly 10 respectively range from about −0.12 mm to about 0.10 mm. Here, the symbol “−” denotes the state in which the recessed portion 30 presses the electrode assembly 10 to be recessed inwardly. Thus, L2 is determined from an uncompressed state, such as prior to assembly or in an area of the electrode assembly 10.

TABLE 1

| | Gap length between | | | | | | |
|---|---|---|---|---|---|---|---|
| | inner surfaces of | | | | | | |
| | recessed portion | Diameter of J/R | L1 − L2 | Drum Test (Defect of electrode tab) | | | Defect of |
| | (L1, mm) | (L2, mm) | (mm) | 100 min. | 130 min. | 150 min. | electrode plate |
| C. example 1 | 17.30 | 17.05 | 0.25 | yes | yes | yes | none |
| C. example 2 | 17.27 | 17.08 | 0.19 | none | yes | yes | none |
| C. example 3 | 17.20 | 17.08 | 0.12 | none | none | yes | none |
| E. example 1 | 17.17 | 17.07 | 0.10 | none | none | none | none |
| E. example 2 | 17.33 | 17.23 | 0.10 | none | none | none | none |
| E. example 3 | 17.31 | 17.22 | 0.09 | none | none | none | none |
| E. example 4 | 17.36 | 17.30 | 0.06 | none | none | none | none |
| E. example 5 | 17.06 | 17.01 | 0.05 | none | none | none | none |
| E. example 6 | 17.17 | 17.13 | 0.04 | none | none | none | none |
| E. example 7 | 17.26 | 17.23 | 0.03 | none | none | none | none |
| E. example 8 | 17.24 | 17.22 | 0.02 | none | none | none | none |
| E. example 9 | 17.10 | 17.22 | −0.12 | none | none | none | none |
| C. example 4 | 17.01 | 17.18 | −0.17 | none | none | none | yes |
| C. example 5 | 17.00 | 17.20 | −0.20 | none | none | none | yes |

Table 1, above, shows whether a defect is generated in the electrode tab 17 and/or 19 and the electrode plates 11 and/or 13 after a drum test is carried out while changing the length of the gap L1 between the inner surfaces 31 of the facing recessed portions 30 and the diameter L2 of the electrode assembly 10. As shown in Table 1, in the experimental examples (E. example) 1 through 9, no defect was generated in either the electrode tab 17 and/or 19 or the electrode plate 11 and/or 13. However, in the comparative examples (C. example) 1 through 3, no defect was generated in the electrode plate 11 and/or 13, but a defect was generated in the electrode tab 17 and/or 19. Thus, as the gap length L3 and L4 between the inner surface of the can 20 and the outer surface 101 of the electrode assembly 10 increases, a defect is more easily generated in the electrode tab 17 and/or 19 because the electrode assembly 10 is more easily moved.

In the comparative examples 4 and 5, no defect was generated in the electrode tab 17 and/or 19, but a defect was generated in the electrode plate 11 and/or 13. Thus, when the electrode assembly 10 is recessed so deeply, movement of the electrode assembly 10 can be prevented, but the electrode plate 11 and/or 13 can be damaged. Therefore, when the gap length L3 and/or L4 between the inner surface of the can 20 and the outer surface 101 of the electrode assembly 30 is relatively large, the electrode assembly 30 can be easily moved, and thus the electrode tab 17 and/or 19 may have a defect such as a crack or a short circuit at a contact portion. However, when the outer surface 101 of the electrode assembly 10 is recessed so deeply to prevent the movement of the electrode assembly 10, the electrode plate 11 and/or 13 can be damaged. As a result, when the sum of both the gap lengths L3 and L4 between the inner surface of the can 20 in which the recessed portions 30 are formed and the outer surface 101 of the electrode assembly 10 ranges from about −0.12 mm to about 0.10 mm, the movement of the electrode assembly 10 can be effectively prevented without the generation of defects in the electrode plates 11 and 13. Alternatively, it can be seen from Table 1 that when the sum of both the gap lengths L3 and L4 ranges from −0.696864% to 0.5858% of the diameter L2 of the electrode assembly, the movement of the electrode assembly 10 can be effectively prevented without the generation of defects in the electrode plates 11 and 13. Similarly, when the (L1−L2) value ranges from −0.696864% to 0.5858% of the diameter L2 of the electrode assembly, the movement of the electrode assembly 10 can be effectively prevented without the generation of defects in the electrode plates 11 and 13.

In the present embodiment, a central axis of the electrode assembly 10 is disposed in the middle of the can 20. However, it is understood that aspects of the present invention are not limited thereto. That is, the central axis of the electrode assembly 10 may be disposed apart from the middle of the can 20, and/or the recessed portions 30 may not face each other. For example, referring to FIG. 4, in the cross-sectional view, the central axis of the electrode assembly 10 is not disposed in the middle of the can 20, and one recessed portion 30 is formed without facing a corresponding recessed portion. In this case, the gap L3 between the inner surface 31 of the recessed portion 30 and the outer surface 101 of the electrode assembly 10 and the gap L4 between an inner surface 22 of the can 20 in which the recessed portion 30 is not formed and the outer surface 101 of the electrode assembly 10 may differ from each other, but the sum (L3+L4) of the gap length L3 between the inner surface 31 of the recessed portion 30 and the outer surface 101 of the electrode assembly 10 and the gap length L4 between the inner surface 22 of the can 20 and the outer surface 101 of the electrode assembly 10 ranges from about −0.12 mm to about 0.10 mm according to aspects of the present invention.

As described above, aspects of the present invention do not necessarily have the recessed portions 30 facing each other, but the recessed portions 30 may be disposed to face each other or not to face each other. In the cross-sectional view, when the recessed portions 30 face each other, the sum of the gap lengths (L3 and L4 in FIG. 3) between the inner surfaces of the can 20 (i.e., the inner surface 31 of the recessed portion 30) in which the recessed portions 30 are disposed and the outer surface 101 of the electrode assembly 10 is maintained in the range from about −0.12 mm to about 0.10 mm. Similarly, when the recessed portions 30 do not face each other, the sum of the gap length (L3 in FIG. 4) between the inner surface of the can 20 in which the recessed portions 30 are disposed (i.e., the inner surface 31 of the recessed portion 31) and the outer surface 101 of the electrode assembly 10 and the gap length (L4 in FIG. 4) between the inner surface 22 of the can 20 in which the recessed portions 30 are not disposed and the outer surface 101 of the electrode assembly 10 is maintained in the range from about −0.12 mm to about 0.10 mm.

FIGS. 5A to 5F are plan and cross-sectional views of various recessed portions according to embodiments of the present invention. At least one recessed portion 30 may be formed along a lengthwise direction of the can 20, as shown in FIGS. 2 through 4, to prevent the movement of the electrode assembly 10. Furthermore, the at least one recessed portion 30 may have a polygonal cross-section. However, it is understood that aspects are not limited thereto. For example, as an alternative, at least one recessed portion 30 may be formed along a circumferential direction of the can 20, as shown in FIG. 5A, and/or may have a semi-circular cross-section as shown in FIG. 5B. As shown in FIG. 5C, the recessed portion 30 may be formed to the same length as the electrode assembly 10 to correspond to a side surface of the electrode assembly 10, or may be formed longer than the electrode assembly 10. As shown in FIGS. 5D to 5F, the recessed portion 30 may be formed to correspond to upper, middle or lower portions of the electrode assembly 10, or may be formed to correspond to at least two different portions. That is, the recessed portion 30 may be formed to correspond to at least one of upper, middle and lower portions of the electrode assembly 10.

According to aspects of the present invention, no defect is generated in an electrode plate 11 and 13 through use of one or more recesses, and movement of an electrode assembly 10 is effectively prevented, thereby increasing stability.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A secondary battery, comprising:
an electrode assembly; and
a can housing the electrode assembly, and having at least one recessed portion in a side surface thereof extending towards the electrode assembly,
wherein a value obtained by subtracting a diameter of the electrode assembly from a gap length between a surface of the at least one recessed portion and a facing inner surface of the can ranges from about −0.12 mm to about 0.10 mm.

2. The secondary battery according to claim 1, wherein the at least one recessed portion is formed along a lengthwise or a circumferential direction of the can.

3. The secondary battery according to claim 1, wherein the at least one recessed portion has a polygonal or a semi-circular cross-section.

4. The secondary battery according to claim 1, wherein the at least one recessed portion is formed to correspond to a height of the outer surface of the electrode assembly.

5. The secondary battery according to claim 1, wherein the at least one recessed portion is formed to correspond to the upper, middle and/or lower portions of the electrode assembly.

6. The secondary battery according to claim 1, wherein:
the at least one recessed portion comprises a first recessed portion and a second recessed portion facing the first recessed portion; and
a value obtained by subtracting the diameter of the electrode assembly from a gap length between inner surfaces of the first and second recessed portions ranges from about −0.12 mm to about 0.10 mm.

7. The secondary battery according to claim 1, wherein:
the at least one recessed portion includes only one recessed portion; and
a sum of a gap length between the inner surface of the can where the recessed portion is disposed and the outer surface of the electrode assembly and a gap length between the inner surface of the can facing the recessed portion and the outer surface of the electrode assembly ranges from about −0.12 mm to about 0.10 mm.

8. The secondary battery according to claim 1, wherein the at least one recessed portion comprises a plurality of recessed portions, no two of which face each other.

9. The secondary battery according to claim 1, wherein the electrode assembly is not centered within the can.

10. A secondary battery, comprising:
an electrode assembly; and
a can housing the electrode assembly, having at least one recessed portion in a side surface thereof extending towards the electrode assembly,
wherein a sum of a gap length between an inner surface of the at least one recessed portion and an outer surface of the electrode assembly and a gap length between the inner surface of the can facing the recessed portion and the outer surface of the electrode assembly ranges from about −0.12 mm to about 0.10 mm.

11. The secondary battery according to claim 10, wherein:
the at least one recessed portion comprises a first recessed portion and a second recessed portion facing the first recessed portion; and
the sum of a gap length between the inner surface of the can where first recessed portion is disposed and an outer surface of the electrode assembly and a gap length between the inner surface of the can where the second recessed portion is disposed and an outer surface of the electrode assembly ranges from about −0.12 mm to about 0.10 mm.

12. The secondary battery according to claim 10, wherein:
the at least one recessed portion includes only one recessed portion; and
a sum of a gap length between the inner surface of the can where the recessed portion is disposed and the outer surface of the electrode assembly and a gap length between the inner surface of the can facing the recessed portion and the outer surface of the electrode assembly ranges from about −0.12 mm to about 0.10 mm.

13. The secondary battery according to claim 10, wherein the at least one recessed portion is formed along a lengthwise or a circumferential direction of the can.

14. The secondary battery according to claim 10, wherein the at least one recessed portion is formed to correspond to a height of the outer surface of the electrode assembly.

15. The secondary battery according to claim 10, wherein the at least one recessed portion is formed to correspond to the upper, middle and/or lower portions of the electrode assembly.

16. The secondary battery according to claim 10, wherein the at least one recessed portion has a polygonal or a semi-circular cross-section.

17. The secondary battery according to claim 10, wherein the at least one recessed portion comprises a plurality of recessed portions, no two of which face each other.

18. The secondary battery according to claim 10, wherein the electrode assembly is not centered within the can.

19. A can to house an electrode assembly of a secondary battery, the can comprising:
a bottom surface;
a side surface extending from the bottom surface to form a housing for the electrode assembly; and
at least one protruding portion extending from the side surface into the housing,
wherein a value obtained by subtracting a diameter of an area to house the electrode assembly from a gap length between the at least one protruding portion and a facing inner surface of the can ranges from −0.696864% to 0.5858% of the diameter of the area to house the electrode assembly.

20. The can according to claim 19, wherein the at least one protruding portion is formed along a lengthwise or a circumferential direction of the can.

21. The can according to claim 19, wherein the at least one protruding portion has a polygonal or a semi-circular cross-section.

22. The can according to claim 19, wherein:
the at least one protruding portion comprises a first protruding portion and a second protruding portion facing the first protruding portion; and
a value obtained by subtracting the diameter of the area to house the electrode assembly from a gap length between inner surfaces of the first and second protruding portions ranges from about −0.12 mm to about 0.10 mm.

23. The can according to claim 19, wherein:
the at least one protruding portion includes only one protruding portion; and
a sum of a gap length between the inner surface of the can where the protruding portion is disposed and an outer circumference of area to house the electrode assembly and a gap length between the inner surface of the can facing the protruding portion and an outer circumference of area to house the electrode assembly ranges from about −0.12 mm to about 0.10 mm.

24. The can according to claim 19, wherein the at least one protruding portion comprises a plurality of protruding portions, no two of which face each other.

25. The can according to claim 19, wherein the value obtained by subtracting the diameter of the area to house the electrode assembly from the gap length between the at least one protruding portion and the facing inner surface of the can ranges from about −0.12 mm to about 0.10 mm.
